(19) United States
(12) Patent Application Publication
(10) Pub. No.: US 2020/0385599 A1
(43) Pub. Date: Dec. 10, 2020

(54) COATING COMPOSITIONS

(71) Applicant: Hewlett-Packard Development Company, L.P, Spring, TX (US)

(72) Inventors: Fereshteh KHORRAMI, San Diego, CA (US); Tao CHEN, San Diego, CA (US); Chau M. HA, San Diego, CA (US); Beverly CHOU, San Diego, CA (US)

(73) Assignee: Hewlett-Packard Development Company, L.P., Spring, TX (US)

(21) Appl. No.: 16/768,463

(22) PCT Filed: Mar. 9, 2018
(86) PCT No.: PCT/US2018/021674

§ 371 Date: May 29, 2020

(51) Int. Cl. C09D 17/00; C09D 109/08; C09D 129/04; C09D 171/02; C08K 3/26; C08K 3/16; B32B 29/08

(52) U.S. Cl. CPC C09D 17/004; C09D 109/08; C09D 129/04; C09D 171/02; C08K 3/26; B32B 2439/62; B32B 29/08; C08K 2003/265; C08K 2201/019; C08K 2003/162; C08K 3/16

(57) ABSTRACT

The present disclosure is drawn to coating compositions that can include from 60 wt % to 90 wt % by dry weight inorganic pigment, a surfactant, latex particles, a polyvinyl alcohol, and a cationic fixing agent. The surfactant includes a fatty alcohol polyglycol ether. The cationic fixing agent can be present in an amount from 4 wt % to 15 wt % by dry weight.

### BACKGROUND

Corrugated linerboard or containerboard packaging is often used as a packaging material. This cellulose fiber-based material includes a fluted medium bonded to one or two flat liner paper faces. The fluted medium and the liner paper are usually made of Kraft pulp. In a typical manufacturing process for corrugated paperboard packaging materials, the fluted medium is first formed by heating and moistening a sheet of corrugating medium and then forming the flute pattern in the sheet using geared wheels. The fluted medium is then bonded using an adhesive to one sheet of liner paper for single-faced corrugated linerboard, or between two sheets of liner paper for double-faced corrugated linerboard or containerboard

Liners for corrugated containerboard are often Kraft brown liners, bleached liners, or white top liners. Printing on the liners is often performed using offset or flexographic printing processes before or after the containerboard has been corrugated.

### BRIEF DESCRIPTION OF THE DRAWINGS

Additional features of the disclosure will be set forth in the detailed description which follows, taken in conjunction with the accompanying drawings, which together illustrate, by way of example, features of the present technology.

FIG. 1 is a cross-sectional view of an example coated base liner, as well as a schematic showing assembly with a fluted medium and backing liner to form a corrugated packaging assembly in accordance with an example of the present disclosure;

FIG. 2 is a cross-sectional view of an alternative example coated base liner after printing in accordance with an example of the present disclosure; and

FIG. 3 is a flowchart of an example method of formulating a coating composition in accordance with an example of the present disclosure.

Reference will now be made to several examples that are illustrated herein, and specific language will be used herein to describe the same. It will nevertheless be understood that no limitation of the scope of the disclosure is thereby intended.

### DETAILED DESCRIPTION

The present disclosure is drawn to coating compositions, such as for corrugated packaging liners. In some examples, a coating composition can include an inorganic pigment, a surfactant, latex particles, a polyvinyl alcohol, and a cationic fixing agent. The inorganic pigment can be included in an amount from 60 wt % to 90 wt % by dry weight. The surfactant includes a fatty alcohol polyglycol ether. The cationic fixing agent can be present in an amount from 4 wt % to 15 wt %. In further examples, the inorganic pigment can be included in an amount from 70 wt % to 90 wt % by dry weight. The polyvinyl alcohol can be included in an amount from 1 wt % to 4 wt % by dry weight. The latex particles can be included in an amount of 4 wt % to less than 10 wt % by dry weight. In one example, the polvyinyl alcohol can have a weight average molecular weight of 150,000 Mw to 400,000 Mw. In further examples, the inorganic pigment can include calcium carbonate. In another example, the coating composition can be devoid of clay. In one example, the coating composition can have a total solids content of 61 wt % to 70 wt %. In another example, the latex particles can be of a styrene-butadiene polymer, e.g., a latex polymer that includes styrene and butadiene polymerized groups.

A coated base liner for corrugated packaging can include a base liner and a coating layer on the base liner. The coating layer can include an inorganic pigment, a surfactant, latex particles, a polyvinyl alcohol, and a cationic fixing agent. The surfactant includes a fatty alcohol polyglycol ether. The cationic fixing agent can be present in an amount from 4 wt % to 15 wt % by dry weight. In certain examples, the coated base liner can be attached to a fluted medium, which can be positioned on an opposite side of the fluted medium relative to a backing liner also attached to the fluted medium. In further examples, the coating layer can have a coat weight of 4 grams per square meter (gsm) to 20 gsm. In other examples, the coating layer can be a single coating layer without a second coating layer applied thereon. In additional examples, the inorganic pigment can be included in an amount from 70 wt % to 90 wt % by dry weight. The polyvinyl alcohol can be present in an amount from 1 wt % to 4 wt % by dry weight. The latex particles can be present in an amount from 4 wt % to less than 10 wt % by dry weight. These dry weight percentages can be with respect to the dry weight of the coating layer. In one example, the inorganic pigment can include calcium carbonate and the coating layer can be devoid of clay.

A method of formulating a coating composition can include dispersing from 60 wt % to 90 wt % by dry weight, with respect to a final dry weight of the coating composition, of inorganic pigment in water with a surfactant to form a pigment dispersion. The surfactant can include a fatty alcohol polyglycol either. Latex particles can be mixed into the pigment dispersion. A polyvinyl alcohol can also be mixed into the pigment dispersion. A cationic fixing agent can be mixed into the pigment dispersion after mixing in the latex particles and the polyvinyl alcohol. The cationic fixing agent can be included in an amount from 4 wt % to 15 wt % by dry weight with respect to the final dry weight of the coating composition. In one example, the inorganic pigment can be included in an amount from 70 wt % to 90 wt % by dry weight. The polyvinyl alcohol can be included in an amount from 1 wt % to 4 wt % by dry weight. The latex particles can be included in an amount from 4 wt % to less than 10 wt % by dry weight, based on the final dry weight of the coating composition. In a further example, the cationic fixing agent can be added at a rate that is slower than rates of addition of the latex particles and the polyvinyl alcohol.

In certain examples, the coating compositions used to prepare the coated base liners and corrugated packing (and in accordance with methods thereof) can be printed upon using inkjet printing. The coating composition can form an ink receiving coating layer on the liner to increase the image quality of images printed on the liner. In many cases, commercial or industrial inkjet printing presses can include fixed printheads and a moving media web to achieve high speed printing, e.g., digital printing press or other high speed printers, such as the HP T400S Web Press® or the HP T1100 Web Press®, which can print at rates from 100 feet per minute to 1,000 feet per minute. Inkjet printheads can use several methods of forming ink droplets, such as forcing ink through nozzles using thermal ejection, piezoelectric pressure, or redirecting a continuous stream of droplets in continuous inkjet printing. Such inkjet presses can often be used to print images and text on coated liners, such as coated base liners, and the printed liners can then be used to make packaging materials such as corrugated cardboard boxes and so on. In other examples, the coated base liners described herein can be printed upon using other printing methods such as offset printing or flexographic printing.

The coating compositions and coated liners described herein can provide good image quality and mechability of images printed on the coated liners, e.g., coated base liners and in some examples coated backing liners. As used herein, “mechability” refers to the ability of a printed medium to go through harsh mechanical processes such as being wound on rollers, stacked with other media, rubbing, and so on without damaging the printed image. In many cases, a coated liner as described herein can be fed through a series of rollers with varying levels of hygiene and dryers at various speeds and temperatures. Depending on the speed at which the liner is fed through the printer and dryers, the drying time may be short. In some cases ink that has not dried can be transferred off the liner onto hot rollers, which can degrade image quality. Although overprint varnish can be added to a printed liner to protect the printed image, the printed liner can still be subject to harsh environments before application of the overprint varnish. Therefore, the coating compositions described herein can be useful for providing good mechability to the printed image even before the overprint varnish is applied.

As used herein, “image quality” can encompass several specific image properties, such as coalescence, optical density, bleeding, gloss, and so on. The coating compositions described herein can provide particularly good coalescence and gloss. Ink coalescence occurs when ink droplets do not absorb sufficiently into the surface of a medium and the droplets then coalesce one with another. This coalescence results in an undesirable non-uniform appearance of the printed ink. Thus, good image quality can include a low level of coalescence. Gloss refers to the ability of a printed image to reflect light back at a particular angle, giving the image a glossy appearance. Harsh calendaring conditions are often used to increase the gloss of printed images. However, the coating compositions described herein can provide good gloss without harsh calendaring conditions.

In some examples, the coating compositions described herein can include a relatively large amount of a cationic fixing agent, such as a metal salt. In some examples, the cationic fixing agent can include calcium chloride (CaCl₂). In some examples, the amount of the cationic fixing agent can be from 4 wt % to 15 wt % by dry weight, or from 6 wt % to 15 wt % by dry weight in other examples. Using this amount of cationic fixing agent can reduce coalescence of ink printed on the coating because the cationic fixing agent can immobilize pigment in the ink on the surface of the media. Typically, using a larger amount of cationic fixing agent, such as greater than 4 wt % or 6 wt %, can have the unwanted side effect of reducing gloss. However, the present coating compositions can also provide acceptable gloss as well as acceptable coalescence. Including a fatty alcohol polyglycol ether surfactant can help to increase the gloss while maintaining low coalescence levels when added compared to not adding the fatty alcohol polyglycol ether surfactant. Furthermore, the fatty alcohol polyglycol ether surfactant, even compared to other types of surfactants that one might expect to also perform similarly, can provide these and other benefits while also providing acceptable coating formulation viscosities. In some examples, the fatty alcohol polyglycol ether surfactant can be added after dispersing inorganic pigment in the coating composition. In further examples, the cationic fixing agent can be added last after the other ingredients in the coating composition, and the cationic fixing agent can be added at a slow rate of mixing.

The coating compositions described herein can also provide good mechability. In some examples, clay can be included as an inorganic pigment in the coating compositions. However, in some cases the mechability of the coated liners can be increased by eliminating clay from the ingredients of the coating composition. In such examples, the inorganic pigment used in the coating composition can consist of or consist essentially of calcium carbonate. In some cases, clay dispersions tend to have a lower solids % than calcium carbonate, and clay dispersions tend to have settling problems. Using calcium carbonate instead of clay can avoid the settling issues and the coating composition can have an overall higher solids content. This can reduce the amount of drying performed to dry the coating after applying the coating composition to a liner.

The addition of polyvinyl alcohol can provide acceptable coatings as well. Polyvinyl alcohol molecular weights ranging from 20,000 Mw to 400,000 Mw can be used, for example. In some examples, depending on the other ingredients that may be present, the mechability of the coating compositions can be further increased by including a high molecular weight polyvinyl alcohol, such as polyvinyl alcohol having a weight average molecular weight of 150,000 Mw to 400,000 Mw. The high molecular weight polyvinyl alcohol can be used instead of a lower molecular weight polyvinyl alcohol, in whole or in part. In some cases, coating compositions for packaging liners may include latexes and cross-linkers to increase mechability as well. However, the higher molecular weight polyvinyl alcohols described herein can, in some examples, allow for a reduction in the amount of latex used and a reduction or elimination of the cross-linker used. Because latex and cross-linkers can sometimes be unpredictable and have negative impacts on coating compositions, removing the cross-linker and reducing the amount of latex can provide a coating composition that may be more consistent with less negative effects. Furthermore, in some examples, a smaller amount of high molecular weight polyvinyl alcohol can be used compared to the amount of low molecular weight polyvinyl alcohol to achieve comparable mechability levels. Thus, there can be a wide variety of polyvinyl alcohol molecular weights that can be used, including low molecular weight PVA, e.g., 20,000 Mw to 130,000 Mw; high molecular weight PVA, e.g., 50,000 Mw to 400,000 Mw; or mixtures thereof. For example, a low molecular weight polyvinyl alcohol can be present at from 0.5 wt % to 3 wt % or from 0.5 wt % to 2 wt %, and a high molecular weight polyvinyl alcohol can be present at from 0.5 wt % to 3 wt % or from 0.5 wt % to 2 wt %. In another example, the total amount of polyvinyl alcohol, including both the high molecular weight and the low molecular weight polyvinyl alcohol, can be from 1 wt % to 6 wt % by dry weight. Regardless, the polyvinyl alcohol can be Mowiol® 4-98 (27,000 Mw); Mowiol® 6-98 (47,000 Mw); Mowiol® 18-88 (130,000 Mw); Mowiol® 40-88 (205,000 Mw); Mowiol® 56-88 (195,000 Mw); and/or Poval™ 235, each from Kuraray (Houston, Tex.). Other low molecular weight polyvinyl alcohol examples can include Mowiol® 4-88, Mowiol® 15-99, and Mowiol® 18-8, also from Kuraray.

In various examples, a coating composition can include an inorganic pigment. In some examples, the inorganic pigment can include calcined clay, modified calcium carbonate, fine or ultra-fine ground calcium carbonate (GCC), precipitated calcium carbonate (PCC), or combinations thereof. In one example, the inorganic pigment can include calcined clay, modified calcium carbonate (MCC), ultra-fine ground calcium carbonate (GCC), precipitated calcium carbonate (PCC), or combinations thereof. In another example, the inorganic pigment can include calcined clay, modified calcium carbonate (MCC), ultra-fine ground calcium carbonate (GCC), or combinations thereof. As mentioned above, in some examples the coating composition can include calcium carbonate and can be devoid of clay. In other examples, the coating composition can include clay in an amount no more than 1 wt % by dry weight.

In one example, the inorganic pigment can include the calcined clay Kaocal® from Thiele Kaolin Company (Sandersville, Ga.) having a particle size distribution of about 83-92% particles finer than 2 μm. In further examples, the inorganic pigment can include ground calcium carbonate such as Hydrocarb® 60 (a fine ground calcium carbonate having a solids content of about 74 wt % and a median diameter of about 1.4 μm), Hydrocarb® 90 (an ultrafine ground calcium carbonate having a solids content of about 76 wt % and a median diameter of about 0.7 μm), or Hydrocarb® 95, available from Omya North America (Cincinnati, Ohio).

In further examples, the inorganic pigment can be ground calcium carbonate; or a mixture of calcined clay and fine ground calcium carbonate; or a mixture of calcined clay and ultrafine ground calcium carbonate; or a mixture of calcined clay and fine ground and ultrafine ground calcium carbonate. In one example, the mixture can contain, by dry weight, at least about 50% of fine and/or ultrafine ground calcium carbonate. In certain examples, the inorganic pigment of the coating composition can include an ultrafine ground calcium carbonate (having a median particle size of about 0.7 μm), calcined clay (having a particle size distribution of about 83-92% particles finer than 2 μm), and/or a combination thereof.

In some examples, the inorganic pigment can have a median particle size ranging from about 0.5 μm to about 5 μm. In another example, the inorganic pigment can have a median particle size ranging from about 0.5 μm to about 2 μm. In still other examples, the inorganic pigment can have a median particle size ranging from about 0.75 μm to about 2 μm, or a median particle size ranging from about 0.5 μm to about 1 μm. As used herein, “particle size” refers to the diameter of a substantially spherical particle (i.e., a spherical or near-spherical particle having a sphericity of >0.84), or the average diameter of a non-spherical particle (i.e., the average of multiple diameters across the particle).

In certain examples, the inorganic pigment can be present in the coating composition in an amount ranging from about 70 wt % to about 90 wt % by dry weight based on the total dry weight of the coating composition.

The coating compositions described herein include a fatty alcohol polyglycol ether surfactant. Fatty alcohol polyglycol ether surfactants can include modified fatty alcohol polyglycol ethers. In a particular example, the fatty alcohol polyglycol ether surfactant can be Disponil® AFX 4030 or 4050 from BASF Corp.

In certain examples, the surfactant can be present in an amount from 0.01 wt % to 2 wt % by dry weight based on the total dry weight of the coating composition. In further examples, the fatty alcohol polyglycol ether surfactant can be present in an amount from 0.05 wt % to 1 wt % by dry weight, or from 0.075 wt % to 0.5 wt % by dry weight.

The coating compositions can also include latex particles. As used herein, the term “latex” refers to a polymer that is capable of being dispersed in an aqueous medium. The latex may act as a binder in the coating composition. In an example, the latex can be present in the coating composition in an amount ranging from 4 wt % to less than 10 wt % by dry weight based on the total dry weight of the coating. In another example, the latex can be present in an amount from 6 wt % to 8 wt % by dry weight.

In various examples, the latex particles can be formed from monomers such as vinyl monomers, allylic monomers, olefin monomers, unsaturated hydrocarbon monomers, or combinations thereof. Classes of vinyl monomers can include vinyl aromatic monomers (e.g., styrene), vinyl aliphatic monomers (e.g., butadiene), vinyl alcohols, vinyl halides, vinyl esters of carboxylic acids (e.g., vinyl acetate), vinyl ethers, (meth)acrylic acid, (meth)acrylates, (meth)acrylamides, (meth)acrylonitriles, or mixtures of two or more of the above, for example. The term “(meth) acrylic latex” can include polymers of acrylic monomers, polymers of methacrylic monomers, and copolymers of the aforementioned monomers with other monomers.

Examples of vinyl aromatic monomers that may be included can include styrene, 3-methylstyrene, 4-methylstyrene, styrene-butadiene, p-chloromethylstyrene, 2-chlorostyrene, 3-chlorostyrene, 4-chlorostyrene, divinyl benzene, vinyl naphthalene and divinyl naphthalene. Vinyl halides can include, for example, vinyl chloride and vinylidene fluoride. Vinyl esters of carboxylic acids can include, for example, vinyl acetate, vinyl butyrate, vinyl methacrylate, vinyl 3,4-dimethoxybenzoate, vinyl maleate and vinyl benzoate. Examples of vinyl ethers can include butyl vinyl ether and propyl vinyl ether.

In other more specific examples, the latex particles in the coating composition can include a styrene-butadiene-based latex, e.g., latex polymer including polymerized styrene and butadiene groups. In one example, the latex particle content can be devoid of any other type of polymer. In more detail, the coating composition can include a styrene-butadiene based latex such as Litex® PX 9710, Litex® 9720, Litex® 9730 or Litex® PX 9740, from Synthomer (Essex, UK). Additional latex types that may be included can include Gencryl® 9525, Gencryl® 9750, and Gencryl® 9780, from Omnova; STR 5401, from Dow Chemical Company (Midland, Mich.), or combinations thereof. In one example, the styrene-butadiene based latex can be carboxylated, e.g., Litex® PX 9740.

The coating composition can also include a cationic fixing agent. In some examples, the cationic fixing agent can include water-soluble mono-valent metallic salts or water-soluble multi-valent metallic salts, where the metallic salt includes (i) a cation of a metal such as a Group I metal, Group II metal, Group III metal, transition metal, or combination thereof, and (ii) an anion such as chloride, iodide, bromide, nitrate, sulfate, sulfite, phosphate, chlorate, acetate, chlorohydrate, and combinations thereof. Some examples of the cation can include sodium, calcium, copper, nickel, magnesium, zinc, barium, iron, aluminum, chromium, or combinations thereof. Some examples of the cationic fixing agent can include calcium chloride, magnesium chloride, calcium bromide, magnesium bromide, calcium nitrate, magnesium nitrate, aluminum chlorohydrate, or combinations thereof. In one example, the cationic fixing agent can be calcium chloride (CaCl₂).

In certain examples, the cationic fixing agent may be present in the coating composition in an amount ranging from 4 wt % to 15 wt % by dry weight based on the total dry weight of the coating composition, or from 6 wt % to 15 wt % by dry weight.

In some examples, a reaction may take place between the cationic fixing agent and an anionic pigment in the ink (e.g., applied to the coated base liner) to fix the anionic pigment. As such, image quality (e.g., bleed, coalescence, text quality, etc.) can be affected by the cationic fixing agent. In some examples, ink can be printed onto the coated liners described herein without applying any additional fixer fluid because the cationic fixing agent in the coating of the coated liner is sufficient to fix pigments in the ink.

In certain examples, the coating composition can have a total solids content of 61 wt % to 70 wt %. In some examples, this high solids content can be achieved by using calcium carbonate instead of clay as the inorganic pigment. Calcium carbonate dispersions can tend to have a higher solids content compared to clay dispersions. In some cases, the coating composition can be diluted after mixing the ingredients to a desired solids content. In one example, the coating composition can be diluted to a solids content from 61 wt % to 65 wt % solids.

Beyond the coating compositions themselves, the present disclosure also extends to coated liners. In various examples, the coated liner can include a base liner and a coating applied to the base liner. The coating can be formed by applying the coating compositions described herein and allowing the coating to dry. The coating can be applied by any coating technique suitable for coating compositions having a viscosity of about 400 cp to 3,000 cp, such as blade coating or rod coating. In one example, the viscosity can be form about 600 cp to about 1800 cp, or in another example, from about 800 cp to about 1200 cp.

In certain examples, the coating layer on the coated liner can have a coat weight of 4 gsm to 20. In other examples, the coating layer can have a coat weight of 5 gsm to 15 gsm. In further examples, the coating layer can be formed as two separate layers that are coated consecutively to form a coating layer. In other examples, the coating layer can be formed as a single coating layer with a single application of the coating composition.

Any suitable type of base liner can be used to make the coated liners described herein. In certain examples, the base liner can be a Kraft liner, a white top liner, or a bleached liner. Kraft linerboard is typically brown, while white top liner board includes a white top surface on top of a brown Kraft base. Bleached liner board can be bleached white all the way through. Base liners can be defined as the liner material on corrugated packaging that is typically used for printing and/or labeling. A backing liner, on the other hand, can be defined as a liner that is used on the opposite side of a fluted medium to provide the corrugated packing structure on both sides of the fluted medium, e.g., the backing liner on one side and the base liner on the other side. In the context of the present disclosure, the base liner is the liner that is coated with the coating compositions described herein which provides a suitable surface for printing thereon, such as by inkjet printing. As a note, the backing liner can be modified similarly with a coating composition applied thereto as well, particularly when there may be utility to printing on both sides of the corrugated packaging.

In the case of white top liners, a white top liner can be made with a clay coating or a layer of white fibers on the top to produce a white appearance. In one example, bleached white fibers can be layered over brown fibers to make a white top liner. Uncoated white top liners can be made with a paper machine having multiple headboxes or otherwise capable of laying down multiple layers of fiber. The combination of layers of brown fibers with bleached white fibers can produce a stronger liner than all bleached fibers, and the cost can be reduced because the brown fibers are cheaper than bleached fibers.

In some examples, the coating composition described herein can be applied during the manufacturing process of the base liner. For example, the coating composition can be applied to a pulp of the base liner when the pulp includes more than 90% solids. The pulp and the coating composition can then be dried to remove liquid from the base liner and the coating layer, forming the coated liner. In other examples, a pre-made dry base liner can be coated with the coating composition.

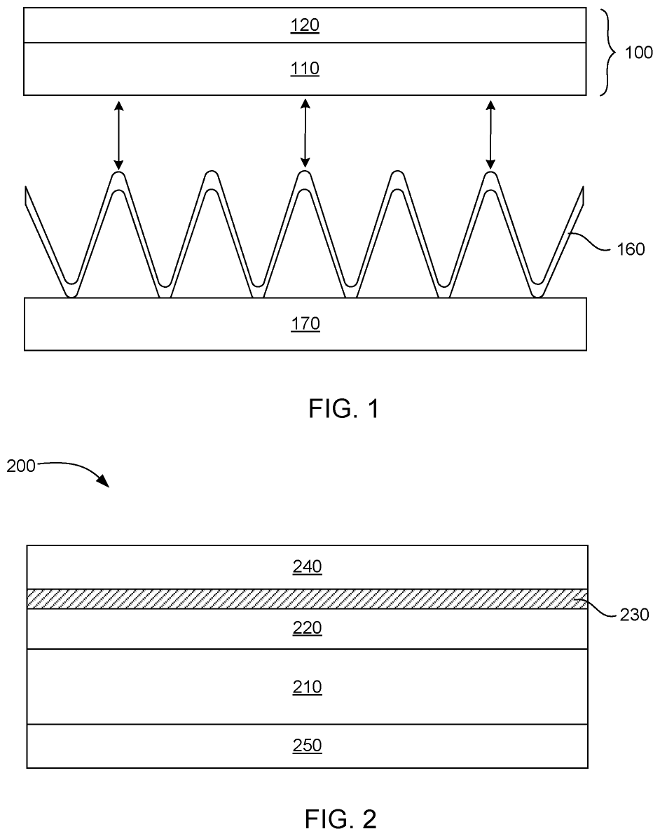

FIG. 1 shows a cross-sectional view of an example coated base liner 100 in accordance with an example of the present disclosure. The coated liner includes a base liner 110 and a coating layer 120 on or applied to the base liner. In one example, the coated base liner can be assembled as corrugated packaging by attaching the coated base liner to a fluted medium 160, which is also attached to a backing liner 170. The backing liner can be positioned opposite the base liner. In some examples, the fluted medium can be formed by pressing a moistened linerboard between geared wheels to form the fluting pattern. The fluted medium can then be glued between the coated liner and the backing liner. In certain examples, the backing liner can also be coated with the coating composition if printing on the backing liner is desired. In other examples, the corrugated packaging may be in the form of a box and the backing liner may be oriented toward the inside of the box where printing on the backing liner would not be visible. In such examples, the backing liner can be uncoated. The corrugated packing can also be arranged in other configurations suitable for packaging.

In certain examples, additional layers can be added to the coated liner during and after the printing process. For example, in some cases a layer of ink can be printed onto the coating layer to form a printed image, followed by a layer of overprint varnish to protect the printed image. In other examples, a curl control layer may be added to the back surface of the base liner to reduce curling of the printed liner. FIG. 2 shows an example coated liner 200 having a base liner 210, a coating layer 220, an ink layer 230, and overprint varnish layer 240, and a curl control layer 250. In certain examples, the curl control layer can include a starch. In further examples, the overprint varnish layer can include an overprint varnish such as Inxkote® AC911 or Inxkote® AC9116 from INX International; Aquaflex® H.R. from Flint Group; or Thermagloss® 1394E, Thermagloss® 426, Thermagloss® 425, Thermagloss® 475, Thermagloss® 460, or Digiguard® gloss 100 from Michelman. The fluted medium and backing liner are not shown in this example, but could be incorporated or attached to this coated liner similarly as that shown in FIG. 1.

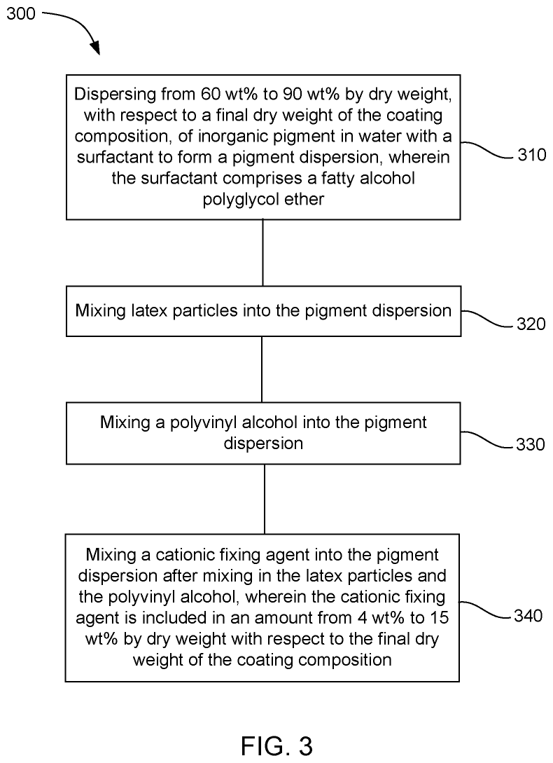

FIG. 3 shows a flowchart of an example method 300 of formulating a coating composition. The method includes dispersing 310 from 60 wt % to 90 wt % by dry weight, with respect to a final dry weight of the coating composition, of inorganic pigment in water with a surfactant to form a pigment dispersion, wherein the surfactant comprises a fatty alcohol polyglycol ether; mixing 320 latex particles into the pigment dispersion; mixing 330 a polyvinyl alcohol into the pigment dispersion 330; and mixing 340 a cationic fixing agent into the pigment dispersion after mixing in the latex particles and the polyvinyl alcohol, wherein the cationic fixing agent is included in an amount from 4 wt % to 15 wt % by dry weight with respect to the final dry weight of the coating composition. In certain examples, the rate of addition of the cationic fixing agent into the pigment dispersion can be slower than the rates of addition of the latex particles and the polyvinyl alcohol.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

The term “coated liner(s)” can refer to coated base liners in accordance with the present disclosure, and in some instances can also include coated backing liners.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if each numerical value and sub-range is explicitly recited. For example, a weight ratio range of about 1 wt % to about 20 wt % should be interpreted to include the explicitly recited limits of 1 wt % and about 20 wt %, and also to include individual weights such as 2 wt %, 11 wt %, 14 wt %, and sub-ranges such as 10 wt % to 20 wt %, 5 wt % to 15 wt %, etc.

As a further note, in the present disclosure, it is noted that when discussing the coating compositions, coated liners, and methods of formulating coating compositions, each of these discussions can be considered applicable to each of these examples, whether or not they are explicitly discussed in the context of that example. Thus, for example, in discussing details about the coating compositions, such discussion also refers to the methods and the coated liners described herein, and vice versa.

### EXAMPLES

### Example 1

### Fatty Alcohol Polyglycol Ether Surfactant

Coating compositions 1-8 were prepared with the compositions shown in Table 1 based on parts by dry weight. Coating compositions 1-4 did not include a fatty alcohol polyglycol ether surfactant. Coating compositions 5-8 included a fatty alcohol polyglycol ether surfactant. All of the coating compositions included 7 parts calcium chloride by dry weight as a cationic fixing agent. The coating compositions were applied to a white top base liner via blade coating to obtain a 15 gsm coating. The coating was dried and then the coated base liner was calendared at 1500 psi at 120° C. Black ink was then printed onto each coated base liner. The 75 degree gloss was measured both in the area printed with black ink and in an unprinted area that was still white. The gloss tests were repeated after applying overprint varnish (OPV) over the printed base liner. The 75 degree gloss test results are shown in Table 1.

TABLE 1

| | Coating Composition Nos. | | | | | | | |
|---|---|---|---|---|---|---|---|---|
| | (Dry parts by weight) | | | | | | | |
| Ingredients | 1 | 2 | 3 | 4 | 5 | 6 | 7 | 8 |
| Hydrocarbe ® 90 | 100 | 100 | 100 | 100 | 100 | 100 | 100 | 100 |
| Disponil ® 4030 AFX | — | — | — | — | 0.1 | 0.1 | 0.1 | 0.1 |
| Litex ® PX9740 | 8 | 12 | 12 | 16 | 8 | 12 | 12 | 16 |
| Mowiol ® 6-98 | 4 | 6 | 4 | 4 | 4 | 6 | 4 | 4 |
| Calcium Chloride | 7 | 7 | 7 | 7 | 7 | 7 | 7 | 7 |
| | 75 degree Gloss | | | | | | | |
| Black Gloss (no OPV) | 61 | 54 | 64 | 66 | 72 | 60 | 63 | 66 |
| Black Gloss (with OPV) | 77 | 74 | 81 | 77 | 83 | 81 | 79 | 79 |
| White Gloss (no OPV) | 55 | 42 | 57 | 64 | 67 | 48 | 55 | 60 |
| White Gloss (with OPV) | 79 | 74 | 79 | 74 | 85 | 78 | 80 | 80 |

Hydrocarb ® 90 is ultrafine ground calcium carbonate from Omya North America;
Disponil ® 4030 AFX is a fatty alcohol polyglycol ether surfactant from BASF;
Litex ® PX9740 is a styrene butadiene-based latex from Synthomer; and
Mowiol ® 6-98 is a polyvinyl alcohol having a Mw of about 47,000 from Kuraray.

It can be seen from Table 1 that adding a fatty alcohol polyglycol ether surfactant can increase gloss, even without an overprint varnish. Using overprint varnish over the printed image can also increase gloss.

### Example 2

### Surfactant Comparison

For comparison of several surfactants, test compositions 9-12 were prepared as shown in Table 2. The compositions each contained a different surfactant. Only the Disponil surfactant of Composition 9 was a fatty alcohol polyglycol ether-type surfactant. The viscosity of the test compositions was measured to identify which surfactants could provide coating compositions with suitable viscosity for use in base liner coating equipment. As a target, a viscosity as close to 1,000 cp as possible was used as a reference point.

TABLE 2

| | Coating Composition Nos. | | | |
|---|---|---|---|---|
| Ingredients | 9 | 10 | 11 | 12 |
| | (Dry parts by weight) | | | |
| Hydrocarb ® 90 | 80 | 80 | 80 | 80 |
| Kaocal ® | 20 | 20 | 20 | 20 |
| Disponil ® 4030 AFX | 0.3 | — | — | — |
| Surfynol ® 440 | — | 0.3 | — | — |
| Carbowet ® GA-211 | — | — | 0.3 | — |
| Dynol ® 360 | — | — | — | 0.3 |
| Litex ® PX9740 | 10 | 10 | 10 | 10 |
| Mowiol ® 4-98 | 5 | 5 | 5 | 5 |
| Ultralube ® D806 | 2 | 2 | 2 | 2 |
| Rhopaque ® AF1055 | 6 | 6 | 6 | 6 |
| Calcium Chloride | 5 | 5 | 5 | 5 |
| | Properties | | | |
| Total % solids | 55.2 | 56.1 | 55.7 | 56.0 |
| Viscosity (cp) | 1632 | 2478 | 3234 | 2526 |

Hydrocarb ® 90 is ultrafine ground calcium carbonate from Omya North America;
Kaocal is a calcined clay from Thiele Kaolin Company;
Disponil ® 4030 AFX is a fatty alcohol polyglycol ether surfactant from BASF;
Surfynol ® 440 is available from Evonik Industries;
Carbowet ® GA-211 is available from Air Products;
Dynol ™ 360 is available from Evonik Industries;
Litex ® PX9740 is a styrene butadiene-based latex from Synthomer;
Mowiol ® 4-98 is a polyvinyl alcohol having a Mw of about 27,000 from Kuraray;
Ultralube ® D806 is a water-based wax dispersion available from Keim-Additec; and
Rhopaque ® AF1055 are hollow sphere pigments available from Dow.

It can be seen from Table 2 that compositions 10 and 12 containing the Surfynol® 440 and Dynol® 360 exhibited very high viscosities. Accordingly, these surfactants were eliminated as candidates for the coating compositions. As shown also at composition 11, an additional test was ran using 7 wt % calcium chloride instead of 5 wt % calcium chloride. In this additional test, the composition containing Carbowet® GA-211 also had a very high viscosity. It was found that Disponil® 4030 AFX provide acceptable viscosities at not only 5 wt % calcium chloride (as shown in Table 2), but also at 7 wt % calcium chloride.

### Example 3

### Eliminating Clay

Coating compositions 13-19 were formulated with the compositions shown in Table 3 based dry parts by weight. The coating compositions were coated onto a white top base liner as two coats of 10 gsm each for a total of 20 gsm and then dried. An inkjet printer was used to print a strip of violet color prepared by printing cyan ink and magenta ink at the highest ink density. The coat weight of the printed ink was 15 gsm. The ink was dried for 3 seconds under a 375° F. dryer. An aluminum roller was then heated to 100° C. and roller directly over the printed ink for three passes. Moving the roller back and forth counted as one pass. The results were then visually compared. Mechability was ranked based on the frequency of ink removal spots and visual damage to the print strip. In the mechability rankings, 3 and higher was acceptable and 5 was the best.

TABLE 3

| | Coating Composition Nos. | | | | | | |
|---|---|---|---|---|---|---|---|
| | (Dry parts by weight) | | | | | | |
| Ingredients | 13 | 14 | 15 | 16 | 17 | 18 | 19 |
| Hydrocarbe ® 90 | 80 | 80 | — | — | — | — | — |
| Hydrocarbe ® 95 | — | — | 80 | 80 | 100 | 100 | 100 |
| Kaocale ® | 20 | 20 | 20 | 20 | — | — | — |
| Disponil ® 4030 AFX | 0.3 | 0.3 | 0.3 | 0.3 | 0.3 | 0.3 | 0.3 |
| Litexe ® PX9740 | 8 | 8 | 8 | 8 | 8 | 8 | 8 |
| Mowiol ® 6-98 | 4 | — | 4 | — | 4 | — | — |
| Mowiol ® 15, 99 | — | 3 | — | 3 | — | 2 | 3 |
| Calcium Chloride | 7 | 7 | 7 | 7 | 7 | 7 | 7 |
| | Properties | | | | | | |
| Max solids % | 56.9 | 60.7 | 56.1 | 59.3 | 60.3 | 65.0 | 64.1 |
| Mechability Rank | 1 | 2.5 | 1 | 2 | 3 | 4 | 4.5 |

Hydrocarb ® 90 and Hydrocarb ® 95 are ultrafine ground calcium carbonate from Omya North America;
Kaocal is a calcined clay from Thiele Kaolin Company;
Disponil ® 4030 AFX is a fatty alcohol polyglycol ether surfactant from BASF;
Litex ® PX9740 is a styrene butadiene-based latex from Synthomer;
Mowiol ® 6-98 and Mowiol ® 15-99 are polyvinyl alcohols from Kuraray.

It can be seen from Table 3 that using calcium carbonate (Hydrocarb® 95) without any clay (Kaocal®) in the coating composition can provide better mechability. This can also show that the max solids wt % in the coating composition can be increased when calcium carbonate is used.

### Example 4

### Corrugated Packaging Assembly

A fluted medium, such as that shown at 160 in FIG. 1, is prepared by pressing a moistened linerboard between laterally elongated geared wheels to form a fluting pattern. The fluted medium is glued between a backing liner and a base liner coated with one of Coating Composition Nos. 5-9 or 13-19. The backing liner may or may not also be coated with one of a coating composition of the present disclosure or some other coating composition. The corrugated packaging, now assembled, can be further configured in the form of a box with the backing liner oriented toward the inside of the box.

While the disclosure has been described with reference to certain examples, various modifications, changes, omissions, and substitutions can be made without departing from the spirit of the disclosure. It is intended, therefore, that the disclosure be limited by the scope of the following claims.

What is claimed is:

1. A coating composition, comprising:
from 60 wt % to 90 wt % by dry weight inorganic pigment;
a surfactant comprising a fatty alcohol polyglycol ether;
latex particles;
a polyvinyl alcohol; and
a cationic fixing agent in an amount from 4 wt % to 15 wt % by dry weight.

2. The coating composition of claim 1, wherein the inorganic pigment is present in an amount from 70 wt % to 90 wt % by dry weight, the polyvinyl alcohol is present in an amount from 1 wt % to 4 wt % by dry weight, and the latex particles are present in an amount of 4 wt % to less than 10 wt % by dry weight.

3. The coating composition of claim 1, wherein the inorganic pigment comprises calcium carbonate and wherein the coating composition does not include clay.

4. The coating composition of claim 1, wherein the cationic fixing agent is a metal salt.

5. The coating composition of claim 1, wherein the coating composition has a total solids content of 61 wt % to 70 wt %.

6. The coating composition of claim 1, wherein the latex particles are of a styrene-butadiene polymer.

7. A coated liner for corrugated packaging, comprising:
a base liner; and
a coating layer on the base liner, the coating layer including:
an inorganic pigment;
a surfactant comprising a fatty alcohol polyglycol ether;
latex particles;
a polyvinyl alcohol; and
a cationic fixing agent in an amount from 4 wt % to 15 wt % by dry weight.

8. The coated liner of claim 7, further comprising a fluted medium attached to a backing liner, wherein the coated liner is also attached to the fluted medium opposite a backing liner.

9. The coated liner of claim 7, wherein the coating layer has a coat weight of 4 gsm to 20 gsm.

10. The coated liner of claim 7, wherein the coating layer is a single coating layer without a second coating layer applied thereon.

11. The coated liner of claim 7, wherein the inorganic pigment is present in an amount from 70 wt % to 90 wt % by dry weight, the polyvinyl alcohol is present in an amount from 1 wt % to 4 wt % by dry weight, and the latex particles are present in an amount of 4 wt % to 10 wt % by dry weight with respect to the weight of the coating layer.

12. The coated liner of claim 7, wherein the wherein the inorganic pigment comprises calcium carbonate and wherein the coating layer does not include clay.

13. A method of formulating a coating composition, comprising:
dispersing from 60 wt % to 90 wt % by dry weight, with respect to a final dry weight of the coating composition, of inorganic pigment in water with a surfactant to form a pigment dispersion, wherein the surfactant comprises a fatty alcohol polyglycol ether;
mixing latex particles into the pigment dispersion;
mixing a polyvinyl alcohol into the pigment dispersion; and
mixing a cationic fixing agent into the pigment dispersion after mixing in the latex particles and the polyvinyl alcohol, wherein the cationic fixing agent is included in an amount from 4 wt % to 15 wt % by dry weight with respect to the final dry weight of the coating composition.

14. The method of claim 13, wherein the inorganic pigment is included in an amount from 70 wt % to 90 wt % by dry weight, the polyvinyl alcohol is included in an amount from 1 wt % to 4 wt % by dry weight, and the latex particles are included in an amount of 4 wt % to less than 10 wt % by dry weight, based on the final dry weight of the coating composition.

15. The method of claim 14, wherein a rate of addition of the cationic fixing agent into the pigment dispersion is slower than rates of addition of the latex particles and the polyvinyl alcohol.
